(19) United States
(12) Patent Application Publication
(10) Pub. No.: US 2026/0194286 A1
(43) Pub. Date: Jul. 9, 2026

(54) REFRIGERATOR

(71) Applicant: SAMSUNG ELECTRONICS CO., LTD., Suwon-si (KR)

(72) Inventors: Hosang PARK, Suwon-si (KR); Sungjun CHO, Suwon-si (KR); Byoungjae CHO, Suwon-si (KR); Sehyeon BAEK, Suwon-si (KR); Ilsung BAE, Suwon-si (KR)

(73) Assignee: SAMSUNG ELECTRONICS CO., LTD., Suwon-si (KR)

(21) Appl. No.: 19/390,043

(22) Filed: Nov. 14, 2025

Related U.S. Application Data
(63) Continuation of application No. PCT/KR2025/017784, filed on Nov. 3, 2025.

(30) Foreign Application Priority Data
Jan. 3, 2025 (KR) 10-2025-0001148
Mar. 18, 2025 (KR) 10-2025-0034938

(51) Int. Cl. F25D 23/02; E05D 7/00

(52) U.S. Cl. CPC F25D 23/02; E05D 7/00; E05Y 2900/31

(57) ABSTRACT

A refrigerator includes a main body, an inner door configured to rotate with respect to the main body, an outer door configured to rotate with respect to the inner door, an inner door shaft rotatably supporting the inner door, and an outer door shaft rotatably supporting the outer door. The inner door includes an inner door panel portion, and an inner door protrusion protruding therefrom and coupled to the inner door shaft. The outer door includes an outer door panel portion, and an outer door groove. The outer door shaft is in the outer door groove. The inner door protrusion, the inner door shaft, and the outer door groove are configured such that, while the outer door is closed with respect to the inner door, the inner door protrusion and the inner door shaft are accommodated in the outer door groove.

### CROSS-REFERENCE TO RELATED APPLICATIONS

This is a continuation application, under 35 U.S.C. § 111(a), of International Application No. PCT/KR 2025/017784, filed Nov. 3, 2025, which claims priority under 35 U.S.C. § 119 to Korean Patent Application No. 10-2025-0001148, filed Jan. 3, 2025, and Korean Patent Application No. 10-2025-0034938, filed Mar. 18, 2025 in the Korean Intellectual Property Office, the disclosures of which are incorporated herein in their entireties by reference.

### TECHNICAL FIELD

The present disclosure relates to a refrigerator.

### BACKGROUND ART

A refrigerator is equipment for keeping food fresh by including a main body having a storage room and a cool air supply system for supplying cool air to the storage room. The storage room includes a refrigerating room that is maintained at about 0° C. to 5° C. to keep food refrigerated and a freezing room that is maintained at about 0° C. to 30° C. below zero to keep food frozen. The front side of the storage room opens to put food therein or take food out.

The refrigerator repeatedly performs a cooling cycle of compressing, condensing, expanding, and evaporating refrigerants through a compressor, a condenser, an expander, and an evaporator. At this time, both the refrigerating room and the freezing room may be cooled through a single evaporator provided in the freezing room, or the freezing room and the refrigerating room may be provided with separate evaporators to be cooled independently.

The refrigerator includes a door that opens or closes the storage room. The door is rotatable with respect to the main body to open or close the storage room. The door applied to the refrigerator includes a double door including an inner door that is rotatable with respect to the main body and an outer door that is rotatable with respect to the inner door.

### DISCLOSURE

### Technical Problem

An aspect of the present disclosure provides a refrigerator for reducing a thickness of a door.

An aspect of the present disclosure provides a refrigerator for reducing and/or preventing interference between a door and a surrounding object such as a cabinet.

An aspect of the present disclosure provides a refrigerator for reducing and/or preventing interference between an inner door and an outer door.

The technical object intended to be achieved by the present document is not limited to the above-mentioned technical objects, and other technical objects not mentioned will be clearly understood by one of ordinary skill in the technical art to which the present disclosure belongs from the following description.

### Technical Solution

A refrigerator according to an embodiment of the present disclosure may include a main body forming a storage room, an inner door configured to rotate with respect to the main body, an outer door configured to rotate with respect to the inner door, an inner door shaft rotatably supporting the inner door with respect to the main body, and an outer door shaft rotatably supporting the outer door with respect to the inner door. The inner door may include an inner door panel portion, and an inner door protrusion protruding from the inner door panel portion toward the outer door and coupled to the inner door shaft. The outer door may include an outer door panel portion facing the inner door panel portion while the outer door is closed with respect to the inner door, and an outer door groove on a rear side of the outer door panel portion. The outer door shaft may be positioned in the outer door groove. The inner door protrusion, the inner door shaft, and the outer door groove may be configured such that, while the outer door is closed with respect to the inner door, the inner door protrusion and the inner door shaft are may be accommodated in the outer door groove.

A refrigerator according to an embodiment of the present disclosure, may include a main body forming a storage room, a hinge bracket fixed to the main body, an inner door configured to rotate with respect to the hinge bracket, an outer door configured to rotate with respect to the inner door, an inner door shaft connecting the hinge bracket to the inner door, and an outer door shaft connecting the inner door to the outer door. The inner door may include an inner door panel portion, and an inner door protrusion protruding from the inner door panel portion toward the outer door. The outer door may include an outer door panel portion facing the inner door panel portion while the outer door is closed with respect to the inner door, and an outer door groove on a rear side of the outer door panel portion and configured to accommodate the inner door protrusion while the outer door covers the inner door. The inner door shaft may be coupled to the inner door protrusion. The outer door shaft may be coupled to an inner wall of the outer door groove.

A refrigerator according to an embodiment of the present disclosure may include a main body forming a storage room, an inner door configured to rotate with respect to the main body, an outer door configured to rotate with respect to the inner door, an inner door upper shaft rotatably supporting an upper portion of the inner door with respect to the main body, an inner door lower shaft rotatably supporting a lower portion of the inner door with respect to the main body, an outer door upper shaft spaced in a vertical direction from the inner door upper shaft and rotatably supporting an upper portion of the outer door with respect to the inner door, and an outer door lower shaft spaced in the vertical direction from the inner door lower shaft and configured to rotatably support a lower portion of the outer door with respect to the inner door. The inner door may include an inner door panel portion, an inner door upper protrusion protruding from an upper portion of the inner door panel portion. The inner door upper shaft may be coupled to the inner door upper protrusion. The inner door may further include an inner door lower protrusion protruding from a lower portion of the inner door panel portion. The inner door lower shaft may be coupled to the inner door lower protrusion. The outer door may include an outer door panel portion, an outer door upper groove on a rear side of an upper portion of the outer door panel portion. The outer door upper shaft may be positioned in the outer door upper groove. The outer door may further include an outer door lower groove on a rear side of a lower portion of the outer door panel portion. The outer door lower shaft may be positioned in the outer door lower groove. While the outer door is closed with respect to the inner door, the inner door upper protrusion and the inner door upper shaft may be accommodated in the outer door upper groove, and the inner door lower protrusion and the inner door lower shaft may be accommodated in the outer door lower groove.

### DESCRIPTION OF DRAWINGS

FIG. 1 is a perspective view of a refrigerator according to an embodiment of the present disclosure.

FIG. 2 is an exploded perspective view showing an inner door and an outer door of a refrigerator according to an embodiment of the present disclosure.

FIG. 3 is an exploded perspective view showing some components, such as an inner door, an outer door shaft, etc., of a refrigerator according to an embodiment of the present disclosure.

FIG. 4 is an enlarged perspective view showing an upper portion of a refrigerator according to an embodiment of the present disclosure.

FIG. 5 is an enlarged perspective view showing some components, such as an inner door, an outer door, an upper hinge bracket, an inner door upper shaft, and an outer door upper shaft, of a refrigerator according to an embodiment of the present disclosure.

FIG. 6 is a top view showing some components, such as an inner door, an outer door, an inner door upper shaft, and an outer door upper shaft, of a refrigerator according to an embodiment of the present disclosure.

FIG. 7 is an enlarged side view showing some components, such as an inner door, an outer door, an upper hinge bracket, an inner door upper shaft, and an outer door upper shaft, of a refrigerator according to an embodiment of the present disclosure.

FIG. 8 is an enlarged top view showing some components, such as an inner door, an outer door, an inner door upper shaft, and an outer door upper shaft, of a refrigerator according to an embodiment of the present disclosure, wherein the outer door and the inner door are in a closed state.

FIG. 9 is an enlarged top view showing some components, such as an inner door, an outer door, an inner door upper shaft, and an outer door upper shaft, of a refrigerator according to an embodiment of the present disclosure, wherein the outer door is opened with respect to the inner door.

FIG. 10 is an enlarged top view showing some components, such as an inner door, an outer door, an inner door upper shaft, and an outer door upper shaft, of a refrigerator according to an embodiment of the present disclosure, wherein the outer door and the inner door are opened with respect to a main body.

FIG. 11 is an enlarged perspective view showing some components, such as an inner door, an outer door, a lower hinge bracket, an inner door lower shaft, and an outer door lower shaft, of a refrigerator according to an embodiment of the present disclosure.

FIG. 12 is a bottom view showing some components, such as an inner door, an outer door, an inner door lower shaft, and an outer door lower shaft, of a refrigerator according to an embodiment of the present disclosure.

FIG. 13 is an enlarged side view showing some components, such as an inner door, an outer door, a lower hinge bracket, an inner door lower shaft, and an outer door lower shaft, of a refrigerator according to an embodiment of the present disclosure.

FIG. 14 is an enlarged bottom view showing some components, such as an inner door, an outer door, an inner door lower shaft, and an outer door lower shaft, of a refrigerator according to an embodiment of the present disclosure, wherein the outer door and the inner door are in a closed state.

FIG. 15 is an enlarged bottom view showing some components, such as an inner door, an outer door, an inner door lower shaft, and an outer door lower shaft, of a refrigerator according to an embodiment of the present disclosure, wherein the outer door is opened with respect to the inner door.

FIG. 16 is an enlarged bottom view showing some components, such as an inner door, an outer door, an inner door lower shaft, and an outer door lower shaft, of a refrigerator according to an embodiment of the present disclosure, wherein the outer door and the inner door are opened with respect to a main body.

### MODES OF THE INVENTION

Various embodiments of the present disclosure and terms used therein are not intended to limit the technical features described in the present disclosure to particular embodiments, and it should be construed as including various modifications, equivalents, or alternatives of a corresponding embodiment.

With regard to description of drawings, similar reference numerals may be used for similar or related components.

A singular form of a noun corresponding to an item may include one item or a plurality of the items unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The term “and/or” includes any and all combinations of one or more of a plurality of associated listed items.

As used herein, such terms as “1^{st}” and “2^{nd}” or “first” and “second” may be used to simply distinguish a corresponding component from another, and does not limit the components in other aspect (for example., importance or order).

Also, in the following description, the terms ‘front surface’, ‘rear surface’, ‘upper surface’, ‘lower surface’, ‘side surface’, ‘left side’, ‘right side’, ‘upper portion’, ‘lower portion’, etc. are defined based on the drawings, and the shapes and positions of components are not limited by the terms.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a certain component is referred to as being “on” or “over” another component, it can be directly on the other component or intervening components may also be present.

A refrigerator according to an embodiment may include a main body.

The “main body” may include an inner case, an outer case positioned outside the inner case, and an insulation provided between the inner case and the outer case.

The “inner case” may include at least one of a case, a plate, a panel or a liner forming a storage room. The inner case may be formed as one body, or may be formed by assembling a plurality of plates together. The “outer case” may form an outer appearance of the main body, and may be coupled to an outer side of the inner case to position the insulation between the inner case and the outer case.

The “insulation” may insulate inside of the storage room from outside of the storage room such that internal temperature of the storage room is maintained at preset optimal temperature without being influenced by an external environment of the storage room. According to an embodiment, the insulation may include a foaming insulation. The foaming insulation may be molded by injecting urethane foam as a mixture of polyurethane and a foaming agent between the inner case and the outer case and foaming the urethane foam.

According to an embodiment, the insulation may further include a vacuum insulation, in addition to a foaming insulation, or the insulation may be configured only with a vacuum insulation, instead of a foaming insulation. The vacuum insulation may include a core material, and a cladding material accommodating the core material therein and sealing inside with vacuum or pressure close to vacuum. However, the insulation is not limited to a foaming insulation or a vacuum insulation mentioned above, and may include various materials capable of being used for insulation.

The “storage room” may include a space defined by the inner case. The storage room may further include an inner case defining a space corresponding to a storage room. Various goods, such as food, medicine, cosmetics, etc., may be stored in the storage room, and the storage room may open in at least one side to put the goods in or take the goods out.

The refrigerator may include one or more storage rooms. Two or more storage rooms formed in the refrigerator may have different purposes of use and may be maintained at different temperatures. To this end, the storage rooms may be partitioned from each other by a partition wall including an insulation.

The storage rooms may be maintained within optimal temperature ranges according to the purposes of use, and may include a “refrigerating room”, a “freezing room”, or a “temperature conversion room” that are divided according to the purposes of use and/or the temperature ranges. The refrigerating room may be maintained at a temperature suitable for keeping goods refrigerated and the freezing room may be maintained at a temperature suitable for keeping goods frozen. The “refrigerating” may mean cooling goods in a range in which the goods are not frozen, and for example, the refrigerating room may be maintained within a range of 0° C. to 7° C. above zero. The “freezing” may mean freezing goods or cooling goods to keep the goods frozen, and for example, the freezing room may be maintained in a range of 1° C. to 20° C. below zero. The temperature conversion room may be used as any one of a refrigerating room or a freezing room according to a user's selection or regardless of a user's selection.

The storage room may be also called various other terms, such as “vegetable room”, “freshness room”, “cooling room”, and “ice-making room”, in addition to “refrigerating room”, “freezing room”, and “temperature conversion room”, and the terms, such as “refrigerating room”, “freezing room”, “temperature conversion room”, etc., as used below need to be understood to represent storage rooms having the corresponding purposes of use and the corresponding temperature ranges.

According to an embodiment, the refrigerator may include at least one door configured to open or close an open side of the storage room. A plurality of doors may be provided to open or close one or more storage rooms independently or a single door may be provided to open or close a plurality of storage rooms. The door may be rotatably or slidably mounted on a front side of the main body.

The “door” may seal the storage room in a closed state. The door may include an insulation, like the main body, to insulate the storage room in the closed state.

According to an embodiment, the door may include a door outer plate forming a front side of the door, a door inner plate forming a rear side of the door and facing the storage room, an upper cap, a lower cap, and a door insulation provided thereinside.

On edges of the door inner plate, a gasket that is tightly pressed against the front side of the main body upon closing of the door to seal up the storage room may be provided. The door inner plate may include a dyke protruding in a rear direction to install a door basket for storing goods thereon.

According to an embodiment, the door may include a door body, and a front panel detachably coupled to a front side of the door body and forming a front side of the door. The door body may include a door outer plate forming a front side of the door body, a door inner plate forming a rear side of the door body and facing the storage room, a upper cap, a lower cap, and a door insulation provided thereinside.

Refrigerators may be classified into a French Door Type, a Side-by-Side type, a Bottom Mounted Freezer, a Top Mounted Freezer, a one-door refrigerator, etc., according to positions of doors and storage rooms.

According to an embodiment of the present disclosure, the refrigerator may include a cool air supply for supplying cool air to the storage room.

The “cool air supply” may be a machine, an apparatus, an electronic device, and/or a combination system thereof, capable of generating cool air and guiding the cool air to cool the storage room.

According to an embodiment, the cool air supply may generate cool air through a cooling cycle including compression, condensation, expansion, and evaporation processes of refrigerants. To this end, the cool air supply may include a cooling cycle device having a compressor, a condenser, an expander, and an evaporator to operate the cooling cycle. According to an embodiment, the cool air supply may include a semiconductor such as a thermoelectric element. The thermoelectric element may cool the storage room by heating and cooling actions through the Peltier effect.

According to an embodiment, the refrigerator may include a machine room where at least some components belonging to the cool air supply are installed.

The “machine room” may be partitioned and insulated from the storage room to prevent heat generated from the components installed in the machine room from being transferred to the storage room. To dissipate heat from the components installed inside the machine room, the machine room may communicate with outside of the main body.

According to an embodiment, the refrigerator may include a dispenser installed in the door to provide water and/or ice. The dispenser may be installed in the door to allow a user to access the dispenser without opening the door.

According to an embodiment of the disclosure, the refrigerator may include an ice maker for forming ice. The ice maker may include an ice making tray storing water, an ice transfer device for separating ice from the ice making tray, and an ice bucket storing ice formed in the ice making tray.

According to an embodiment, the refrigerator may include a controller for controlling the refrigerator.

The “controller” may include a memory for storing and/or memorizing data and/or programs for controlling the refrigerator, and a processor for outputting control signals for controlling the cool air supply, etc. according to the programs and/or data memorized in the memory.

The memory may store or record various information, data, instructions, programs, etc. required for operations of the refrigerator. The memory may memorize temporary data generated while a control signal for controlling components included in the refrigerator is generated. The memory may include at least one of a volatile memory or a non-volatile memory, or a combination of a volatile memory and a non-volatile memory.

The processor may control overall operations of the refrigerator. The processor may execute a program stored in the memory to control components of the refrigerator. The processor may include a neural network processing unit (NPU) that performs operations of an artificial intelligence model. Also, the processor may include a central processing unit (CPU), a graphic processor unit (GPU), and the like. The processor may generate a control signal for controlling operations of the cool air supply. For example, the processor may receive temperature information about a temperature of the storage room from a temperature sensor and generate a cooling control signal for controlling operations of the cool air supply based on the temperature information of the storage room.

Also, the processor may process a user input received through a user interface and control operations of the user interface according to the programs and/or data stored/memorized in the memory. The user interface may be provided by using an input interface and an output interface. The processor may receive a user input from the user interface. Also, the processor may transfer a display control signal and image data for displaying an image on the user interface to the user interface in response to the user input.

The processor and memory may be provided integrally or separately. The processor may include one or more processors. For example, the processor may include a main processor and at least one sub processor. The memory may include one or more memories.

According to an embodiment, the refrigerator may include a processor and a memory for controlling all components included in the refrigerator and may include a plurality of processors and a plurality of memories for individually controlling the components of the refrigerator. For example, the refrigerator may include a processor and a memory that control operations of the cool air supply according to an output from the temperature sensor. In addition, the refrigerator may include a processor and a memory that control operations of the user interface according to a user input.

A communication module may communicate with an external device, such as a server, a mobile device, or another home appliance, through an access point (AP) around the communication module. The AP may connect a local area network (LAN) to which the refrigerator or a user device is connected to a wide area network (WAN) to which a server is connected. The refrigerator or the user device may be connected to the server through the WAN.

The input interface may include a key, a touch screen, a microphone, and the like. The input interface may receive a user input and transfer the user input to the processor.

The output interface may include a display, a speaker, and the like. The output interface may output various notifications, messages, information, etc. generated by the processor.

Hereinafter, an embodiment of the disclosure will be described in detail with reference to the accompanying drawings.

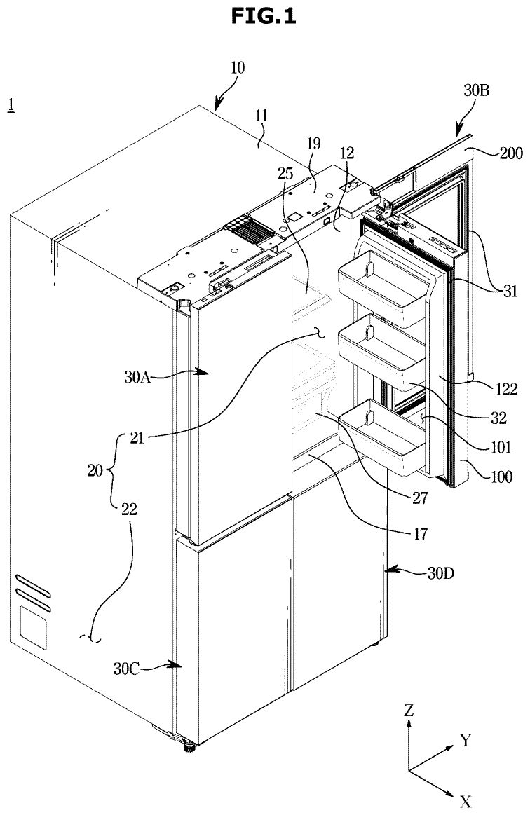

In the following descriptions about various embodiments of the present disclosure with reference to FIGS. 1 to 16, the terms “upper direction”, “lower direction”, “front direction”, “rear direction”, “left side”, “right side”, etc. are defined based on the drawings, and shapes and positions of components are not limited by the terms. For example, the terms “upper direction” and “lower direction” may be an upper direction and a lower direction in a Z direction in the drawings. The terms “front direction” and “rear direction” may be a front direction and a rear direction in a X direction in the drawings. The terms “left side” and “right side” may be a left side and a right side in a Y direction in the drawings.

In the following descriptions about various embodiments of the present disclosure with reference to FIGS. 1 to 16, the term ‘hinge bracket’ may be used as the term including an upper hinge bracket 41 and a lower hinge bracket 42.

In the following descriptions about various embodiments of the present disclosure with reference to FIGS. 1 to 16, the term ‘inner door shaft’ may be used as the term including an inner door upper shaft 51 and an inner door lower shaft 52.

In the following descriptions about various embodiments of the present disclosure with reference to FIGS. 1 to 16, the term ‘outer door shaft’ may be used as the term including an outer door upper shaft 61 and an outer door lower shaft 62.

In the following descriptions about various embodiments of the present disclosure with reference to FIGS. 1 to 16, the term ‘inner door protrusion’ may be used as the term including an inner door upper protrusion 140 and an inner door lower protrusion 150.

In the following descriptions about various embodiments of the present disclosure with reference to FIGS. 1 to 16, the term ‘inner door shaft hole’ may be used as the term including an inner door upper shaft hole 141 and an inner door lower shaft hole 151.

In the following descriptions about various embodiments of the present disclosure with reference to FIGS. 1 to 16, the term ‘inner door groove’ may be used as the term including an inner door upper groove 142 and an inner door lower groove 152.

In the following descriptions about various embodiments of the present disclosure with reference to FIGS. 1 to 16, the term ‘outer door groove’ may be used as the term including an outer door upper groove 240 and an outer door lower groove 250.

In the following descriptions about various embodiments of the present disclosure with reference to FIGS. 1 to 16, the term ‘side groove’ may be used as the term including a side upper groove 202a and a side lower groove 202b.

FIG. 1 is a perspective view of a refrigerator according to an embodiment of the present disclosure.

Referring to FIG. 1, a refrigerator 1 according to an embodiment of the present disclosure may include a main body 10, a storage room 20 provided inside the main body 10, one or more doors (for example, a first door 30A, a second door 30B, a third door 30C, and a fourth door 30D) that open or close the storage room 20, and a cooling system for supplying cool air to the storage room 20.

The main body 10 may include an inner case 12 forming the storage room 20 and an outer case 11 forming an appearance of the refrigerator 1. The outer case 11 may be formed substantially in a shape of a box of which a front side opens. The outer case 11 may form a top, a bottom, left and right sides, and a rear side of the refrigerator 1. A front side of the inner case 12 may open. The inner case 12 may form the storage room 20 therein and be positioned inside the outer case 11. An inner wall of the inner case 12 may form an inner wall of the storage room 20.

A main body insulation may be provided between the inner case 12 and the outer case 11 to insulate between the inner case 12 and the outer case 11. The main body insulation may be foamed between the inner case 12 and the outer case 11. The main body insulation may couple the inner case 12 to the outer case 11. The main body insulation may prevent heat exchange between inside of the storage room 20 and outside of the main body 10, thereby improving cooling efficiency inside the storage room 20. For example, the main bod insulation may include various insulations, such as a urethane foam insulation, an expanded polystyrene (EPS) insulation, a vacuum insulation, etc.

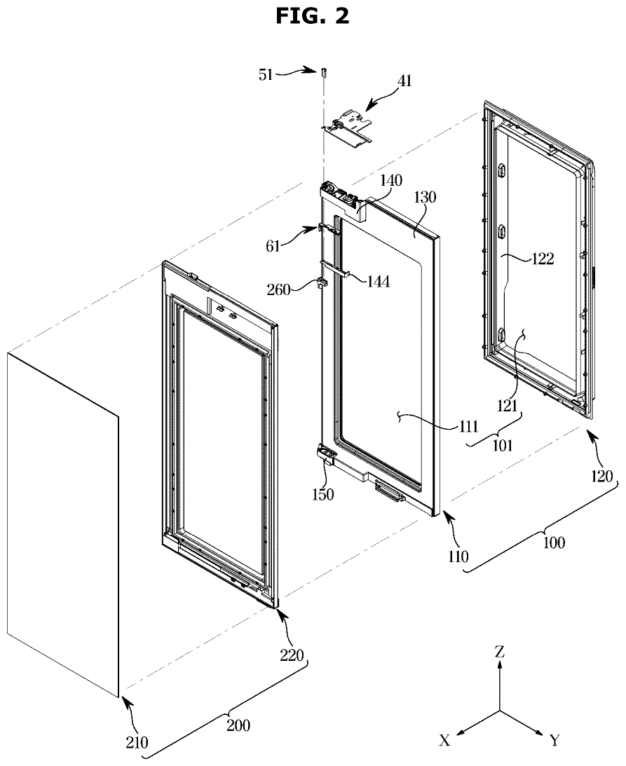

The main body 10 may include a top table 19. The top table 19 may be coupled to an upper surface of the outer case 11. For example, the top table 19 may cover various electronic components. For example, the top table 19 may cover the upper hinge bracket 41 (see FIG. 2, etc.) which will be described below. For example, the top table 19 may cover the inner door upper shaft 51 (see FIG. 2, etc.) which will be described below.

The storage room 20 may be formed inside the main body 10. For example, the storage room 20 may include a refrigerating room that is maintained at about 0° C. to 5° C. to keep food refrigerated. For example, the storage room 20 may include a freezing room that is maintained at about 23° C. to 17° C. below zero to keep food frozen.

In various embodiments, the storage room 20 may be partitioned into a plurality of areas. The storage room 20 may be partitioned into a plurality of areas by a partition 17. For example, the storage room 20 may be partitioned into an upper storage room 21 and a lower storage room 22 by a partition 17 extending in a horizontal direction. For example, the lower storage room 22 may be partitioned into a left storage room and a right storage room by a partition extending in a vertical direction. For example, the upper storage room 21 may be used as a refrigerating room and the lower storage room 22 may be used as a freezing room.

However, the above-described partitioning of the storage room 20 and purposes of use of the storage rooms 21, 22, and 23 are only examples, and the present disclosure is not limited thereto.

Inside the storage rooms 21, 22, and 23, a shelf 25 on which food is put and a drawer for keeping food may be provided.

The refrigerator 1 may include a cooling system for generating cool air by using a cooling cycle and supplying the generated cool air to the storage rooms 21, 22, and 23. The cooling system may generate cool air by using a cooling circulation cycle of compressing, condensing, expanding, and evaporating refrigerants. For example, the cooling system may include a compressor, a condenser, an expansion valve, an evaporator, and a blowing fan. Cool air generated by the cooling system may be supplied to the storage room 20 through a cool air supply duct formed in a rear portion of the inner case 12.

The door (for example, the first door 30A, the second door 30B, the third door 30C, and the fourth door 30D) may open or close the storage room 20. The door may open or close an opening formed in one side of the main body 10. The door may be rotatable with respect to the main body 10.

A front side of the door may form a part of the appearance of the refrigerator 1. While the door is at a closed position, the front side of the door may form at least a part of a front appearance of the refrigerator 1. While the door is at the closed position, a rear side of the door may face the inside of the storage room 20. Here, the rear side of the door may be one side of the door facing the storage room 20 while the door closes the storage room 20. Also, the front side of the door may be another side of the door, which is opposite to the rear side of the door facing the storage room 20 while the door closes the storage room 20, and the front side of the door may be one side of the door that is visible when a user looks at the refrigerator 1 from the front.

On the rear side of the door, a door shelf 32 may be provided to store food. For example, the door shelf 32 may be supported by a dyke 122 that protrudes from the rear side of the door. The door shelf 32 may be mounted on the dyke 122.

On the rear side of the door, a door gasket 31 may be provided. For example, the door gasket 31 may cover a gap between the door and the main body 10 to prevent cool air of the storage room 20 from leaking out. For example, the door gasket 31 may cover a gap between an outer door 200 and an inner door 100 which will be described below to prevent cool air of the storage room 20 from leaking out. The door gasket 31 may include various elastic materials, such as rubber, silicon, etc. to be elastically deformable.

According to an embodiment, the refrigerator 1 may include an upper door and a lower door aligned in the vertical direction Z. The refrigerator 1 may include a left door and a right door aligned in a left-right direction Y. The refrigerator 1 may include a plurality of doors 30A, 30B, 30C, and 30D that open or close the respective storage rooms 21 and 22.

According to an embodiment, the upper storage room 21 may be opened or closed by a pair of upper doors 30A and 30B. The refrigerator 1 may include the first door 30A that opens or closes an area of the upper storage room 21, and the second door 30B that opens or closes another area of the upper storage room 21. Each of the first door 30A and the second door 30B may be rotatable with respect to the main body 10. The first door 30A and the second door 30B may be arranged side by side in the left-right direction (Y direction). For example, the first door 30A may open or close a left area of the upper storage room 21, and the second door 30B may open or close a right area of the upper storage room 21.

According to an embodiment, the lower storage room 22 may be opened or closed by lower doors 30C and 30D. The refrigerator 1 may include the third door 30C that opens or closes the left storage room of the lower storage room 22. The refrigerator 1 may include the fourth door 30D that opens or closes the right storage room of the lower storage room 22. The third door 30C and the fourth door 30D may be rotatable with respect to the main body 10. For example, the first door 30A and the third door 30C may be aligned in the vertical direction Z. For example, the second door 30B and the fourth door 30D may be aligned in the vertical direction Z. For example, the third door 30C and the fourth door 30D may be aligned in the left-right direction Y.

According to an embodiment, the refrigerator 1 may include an inner door 100 that is rotatable with respect to the main body 10, and an outer door 200 that is rotatable with respect to the inner door 100. For example, each of the first door 30A and the second door 30B may include the inner door 100 and the outer door 200. That is, each of the first door 30A and the second door 30B may include a double door.

The inner door 100 may be rotatably coupled to the main body 10. The inner door 100 may be rotatably coupled to the main body 10 by a hinge bracket and an inner door shaft which will be described below. The inner door 100 may open or close the storage room 20 by rotating with respect to the main body 10.

While the inner door 100 is at a closed position, a rear side of the inner door 100 may face the storage room 20. The door gasket 31 may be positioned on the rear side of the inner door 100. The dyke 122 may protrude from the rear side of the inner door 100.

While the inner door 100 is at the closed position, a front side of the inner door 100, which is opposite to the rear side, may face the front direction which is opposite to the storage room 20.

The inner door 100 may have an opening 101. The inner door 100 may be in a shape of a frame having the opening 101. The opening 101 of the inner door 100 may extend between the front side and the rear side. The opening 101 of the inner door 100 may be formed by penetrating the inner door 100 in a front-rear direction.

The outer door 200 may be rotatably coupled to the inner door 100. The outer door 200 may be rotatably coupled to the inner door 100 by an outer door shaft which will be described below. The outer door 200 may cover or not cover the inner door 100 by rotating with respect to the inner door 100. The outer door 200 may open or close the opening 101 of the inner door 100 by rotating with respect to the inner door 100. While both the inner door 100 and the outer door 200 are in a closed state, the outer door 200 may cover the inner door 100 and close the opening 101 of the inner door 100. While both the inner door 100 and the outer door 200 are in the closed state, the outer door 200 may be positioned in front of the inner door 100. While the inner door 100 is closed and the outer door 200 is opened, the outer door 200 may not cover the inner door 100 and open the opening 101 of the inner door 100.

While the outer door 200 is at a closed position with respect to the inner door 100, a rear side of the outer door 200 may face the inner door 100. While the outer door 200 is at the closed position with respect to the inner door 100, the rear side of the outer door 200 may cover the front side of the inner door 100. While both the inner door 100 and the outer door 200 are at a closed position, the rear side of the outer door 200 may face the storage room 20. The door gasket 31 may be positioned on the rear side of the outer door 200.

While the outer door 200 is at a closed position, a front side of the outer door 200, which is opposite to the rear side, may face the front direction and form a part of the front appearance of the refrigerator 1.

While the inner door 100 is closed with respect to the main body 10 and the outer door 200 is closed with respect to the inner door 100 to cover the inner door 100, the storage room 20 may be closed. While both the inner door 100 and the outer door 200 are opened, the storage room 20 may be opened. While the inner door 100 is closed with respect to the main body 10 and the outer door 200 is opened with respect to the inner door 100 not to

cover the inner door 100, the storage room 20 may be opened through the opening 101 to allow an access.

Hereinafter, structures of the inner door 100 and the outer door 200 will be described in detail based on the first door 30A. However, the structures may also be applied to the second door 30B correspondingly.

A configuration of the refrigerator 1 described above with reference to FIG. 1 is only an example of the present disclosure, and a configuration of the refrigerator 1 according to various embodiments of the present disclosure is not limited thereto. A refrigerator according to various embodiments of the present disclosure may include various components for performing a function of supplying cool air to a storage room for storing food.

For example, the refrigerator 1 according to an embodiment as shown in FIG. 1 is a French door type. However, the present disclosure is not limited thereto. In various embodiments of the present disclosure, the refrigerator 1 may include various types of refrigerators, such as a one-door type, a Bottom Mounted Freezer (BMF) type in which a refrigerating room is positioned in the upper side and a freezing room is positioned in the lower side, a Top Mounted Freezer (TMF) type in which a freezing room is positioned in the upper side and a refrigerating room is positioned in the lower side, and a side-by-side type in which a refrigerating room and a freezing room are positioned side by side in a left-right direction.

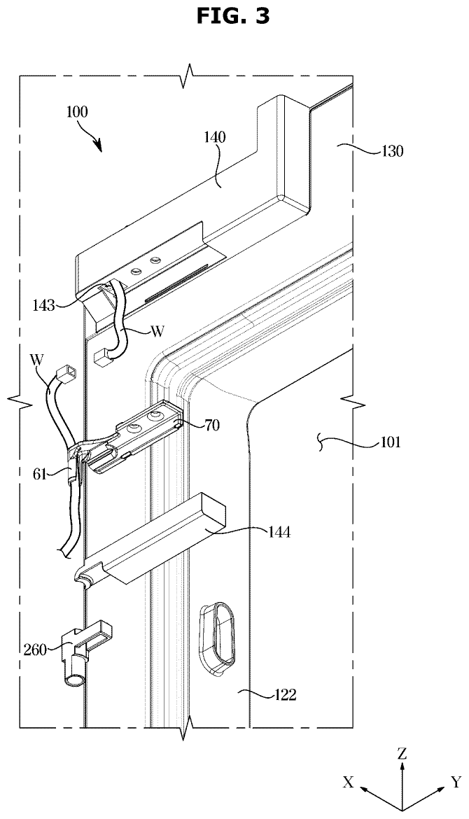

FIG. 2 is an exploded perspective view showing an inner door and an outer door of a refrigerator according to an embodiment of the present disclosure. FIG. 3 is an exploded perspective view showing some components, such as an inner door, an outer door shaft, etc., of a refrigerator according to an embodiment of the present disclosure.

Referring to FIGS. 2 and 3, each of the inner door 100 and the outer door 200 of the refrigerator 1 according to an embodiment of the present disclosure may include a plurality of frames.

According to an embodiment, the outer door 200 may include a first outer door frame 210 and a second outer door frame 220. The first outer door frame 210 may be coupled to the second outer door frame 220. The first outer door frame 210 may be coupled to a front portion of the second outer door frame 220. The first outer door frame 210 may form the front side of the outer door 200. The second outer door frame 220 may form the rear side of the outer door 200. For example, the door gasket 31 may be arranged on a rear side of the second outer door frame 220.

A door insulation may be provided between the first outer door frame 210 and the second outer door frame 220. The door insulation may include various insulations, such as an urethane foam insulation, an EPS insulation, a vacuum insulation, etc.

According to an embodiment, the inner door 100 may include a first inner door frame 110 and a second inner door frame 120. The first inner door frame 110 may be coupled to the second inner door frame 120. The first inner door frame 110 may be coupled to a front portion of the second inner door frame 120. The first inner door frame 110 may form a front side of the inner door 100. The second inner door frame 120 may form a rear side of the inner door 100. For example, the door gasket 31 may be arranged on a rear side of the second inner door frame 120. For example, the dyke 122 may protrude from the second inner door frame 120.

The first inner door frame 110 may include an opening 111. The second inner door frame 120 may include an opening 121. The opening 111 of the first inner door frame 110 may be formed to correspond to the opening 121 of the second inner door frame 120. The opening 111 of the first inner door frame 110 may be connected to the opening 121 of the second inner door frame 120 to form the opening 101 of the inner door 100. Each of the first inner door frame 110 and the second inner door frame 120 may be in a shape of a frame having an opening.

A door insulation may be provided between the first inner door frame 110 and the second inner door frame 120. The door insulation may include various insulations, such as an urethane foam insulation, an EPS insulation, a vacuum insulation, etc.

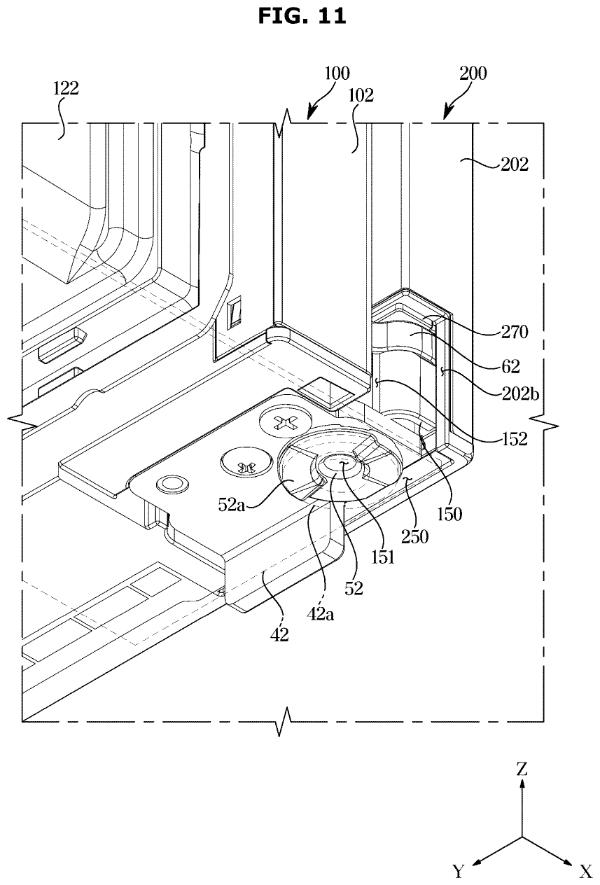

According to an embodiment, the refrigerator 1 may include the inner door shaft (for example, the indoor door upper shaft 51 and the inner door lower shaft 52 (see FIG. 11)) and the hinge bracket (for example, the upper hinge bracket 41 and the lower hinge bracket 42 (see FIG. 11)).

The inner door 100 may be rotatable with respect to the main body 10 by the inner door shaft (for example, the inner door upper shaft 51 and the inner door lower shaft 52 (see FIG. 11)). The inner door 100 may be coupled to the inner door shaft. The inner door shaft may extend in a direction of a rotation axis of the inner door 100 with respect to the main body 10. For example, the rotation axis of the inner door 100 with respect to the main body 10 may pass through a substantially center of the inner door shaft. For example, a central axis of the inner door shaft may be identical to the rotation axis of the inner door 100. For example, the inner door shaft may extend in the vertical direction Z. For example, the inner door shaft may be coupled to the first inner door frame 110.

The hinge bracket (for example, the upper hinge bracket 41 and the lower hinge bracket 42 (see FIG. 11)) may be coupled to the main body 10 and the inner door shaft. The inner door 100 may be supported to the main body 10 by the hinge bracket. The inner door 100 may be connected to the main body 10 by the inner door shaft and the hinge bracket.

According to an embodiment, the refrigerator 1 may include the outer door shaft (for example, the outer door upper shaft 61 and the outer door lower shaft 62 (see FIG. 11)).

The outer door 200 may be rotatable with respect to the inner door 100 by the outer door shaft (for example, the outer door upper shaft 61 and the outer door lower shaft 62 (see FIG. 11)). The outer door 200 may be coupled to the outer door shaft. The outer door shaft may extend in a direction of a rotation axis of the outer door 200 with respect to the inner door 100. For example, the rotation axis of the outer door 200 with respect to the inner door 100 may pass through a substantially center of the outer door shaft. For example, a central axis of the outer door shaft may be identical to the rotation axis of the outer door 200. For example, the outer door shaft may extend in the vertical direction Z. For example, the outer door shaft may be coupled to the second outer door frame 220.

According to an embodiment, the outer door 200 may include a shaft guide (for example, an upper shaft guide 260 and a lower shaft guide 270 (see FIG. 11)) to which the outer door shaft (for example, the outer door upper shaft 61 and the outer door lower shaft 62 (see FIG. 11)) is coupled. For example, the outer door shaft may be coupled to the outer door 200 by being inserted into the shaft guide. For example, the outer door shaft may be coupled to the second outer door frame 220.

According to an embodiment, the refrigerator 1 may include an outer door hinge bracket 70. The outer door hinge bracket 70 may support the outer door shaft (for example, the outer door upper shaft 61 and the outer door lower shaft 62 (see FIG. 11)). For example, the outer door hinge bracket 70 may be coupled to the inner door 100 to support the outer door shaft. For example, the outer door hinge bracket 70 may connect the outer door shaft to the inner door 100.

According to an embodiment, the outer door shaft (for example, the outer door upper shaft 61 and the outer door lower shaft 62 (see FIG. 11)) may be integrated into the outer door hinge bracket 70. Unlike this, in various embodiments, the outer door shaft (for example, the outer door upper shaft 61 and the outer door lower shaft 62 (see FIG. 11) and the outer door hinge bracket 70 may be provided as separate components and then coupled to each other. Alternatively, in various embodiments, the outer door shaft (for example, the outer door upper shaft 61 and the outer door lower shaft 62 (see FIG. 11)) may be coupled directly to the inner door 100.

According to an embodiment, the outer door upper shaft 61 may be supported on the inner door upper protrusion 140 which will be described below (see FIG. 3). According to an embodiment, the outer door upper shaft 61 may be coupled to the inner door upper protrusion 140 by the outer door hinge bracket 70.

According to an embodiment, the main body 10, the inner door 100, and the outer door 200 may be connected to each other by a wire W. Electronic components arranged in the top table 19 may be connected to the inner door 100 and the outer door 200 through the wire W.

For example, a part of the wire W may pass through the inner door upper shaft 51. The wire W may connect electronic components in the main body 10 to the inner door 100 through the inner door upper shaft 51.

For example, a part of the wire W may pass through the outer door upper shaft 61. The wire W may connect the inner door 100 to the outer door 200 through the outer door upper shaft 61.

For example, a part of the wire W may pass through a wire hole 143 provided in the inner door 100. The wire hole 143 may be formed in the inner door upper protrusion 140 which will be described. The wire W extending from the inner door upper shaft 51 may pass through the wire hole 143 and extend toward the outer door 200.

For example, the inner door upper protrusion 140 which will be described below may form a space where the wire W extending from the inner door upper shaft 51 is connected to the wire W extending from the outer door upper shaft 61. In the inner door upper protrusion 140, any one of the wire W extending from the inner door upper shaft 51 or the wire W extending from the outer door upper shaft 61 may pass through the wire hole 143. For example, the space where the wires W are connected to each other may be formed below the wire hole 143, and the wire W extending from the inner door upper shaft 51 may pass through the wire hole 143 and be connected to the wire W extending from the outer door upper shaft 61.

For example, the wire hole 143, the space where the wires W are connected to each other, and a part of the wires W positioned in the space may be covered by a lower cap 144. The lower cap 144 may be provided below the inner door upper protrusion 140 which will be described below. For example, the lower cap 144 may be coupled to the upper shaft guide 260, but the present disclosure is not limited thereto.

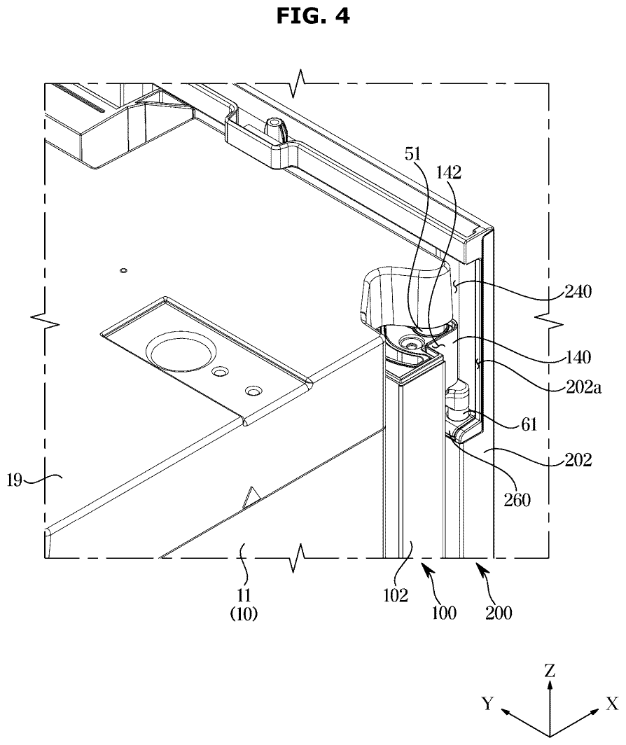

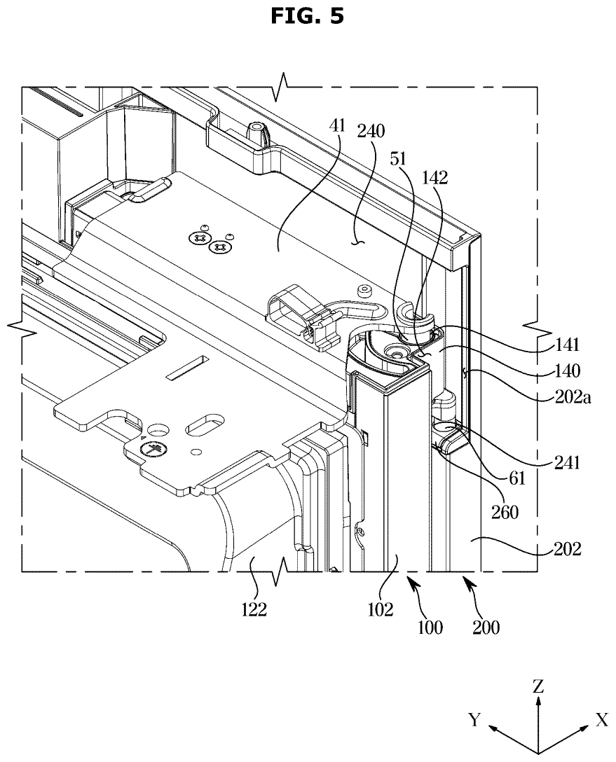

FIG. 4 is an enlarged perspective view showing an upper portion of a refrigerator according to an embodiment of the present disclosure, FIG. 5 is an enlarged perspective view showing some components, such as an inner door, an outer door, an upper hinge bracket, an inner door upper shaft, and an outer door upper shaft, of a refrigerator according to an embodiment of the present disclosure.

A door shaft and a hinge bracket coupled to upper portions of the inner door 100 and the outer door 200 according to an embodiment of the present disclosure will be described with reference to FIGS. 4 and 5.

According to an embodiment, the refrigerator 1 may include the inner door upper shaft 51 that rotatably supports the inner door 100 with respect to the main body 10. The inner door 100 may rotate on the inner door upper shaft 51. The inner door upper shaft 51 may extend in the direction (for example, the vertical direction Z) of the rotation axis of the inner door 100 with respect to the main body 10.

The inner door upper shaft 51 may support an upper portion of the inner door 100. The inner door upper shaft 51 may be coupled to the upper portion of the inner door 100. For example, the inner door upper shaft 51 may be coupled to an upper portion of the first inner door frame 110.

The inner door 100 may include an inner door upper shaft hole 141 in which the inner door upper shaft 51 is inserted. For example, the inner door upper shaft hole 141 may be positioned in a top of the inner door 100. For example, the inner door upper shaft 51 may extend downward from an upper side of the inner door upper shaft hole 141 and be inserted into the inner door upper shaft hole 141. According to the inner door upper shaft 51 being inserted into the inner door upper shaft hole 141, the inner door upper shaft 51 may be coupled to the inner door 100 and rotatably support the inner door 100. For example, the inner door upper shaft hole 141 may be provided in the first inner door frame 110.

The inner door upper shaft 51 may be positioned adjacent to one side 102 of the inner door 100. The one side 102 of the inner door 100 may be one side (for example, a left side of the inner door 100 included in a left door or a right side of the inner door 100 included in a right door) adjacent to the inner door upper shaft 51 among both sides of the inner door 100 in a direction (for example, the left-right direction Y) that is perpendicular to an extension direction (for example, the vertical direction Z) of the inner door upper shaft 51. According to the inner door upper shaft 51 being positioned adjacent to the one side 102 of the inner door 100, the inner door 100 may be efficiently prevented from interfering with the main body 10 while rotating with respect to the main body 10.

According to an embodiment, the refrigerator 1 may include the upper hinge bracket 41 that connects the upper portion of the inner door 100 to an upper portion of the main body 10. The upper hinge bracket 41 may be coupled to the upper portion of the main body 10. The upper hinge bracket 41 may be coupled to the inner door shaft 51. The upper hinge bracket 41 may be coupled to the inner door upper shaft 51 and rotatably support the inner door 100.

According to an embodiment, the refrigerator 1 may include the outer door upper shaft 61 that rotatably supports the outer door 200 with respect to the inner door 100. The outer door 200 may rotate on the outer door upper shaft 61. The outer door upper shaft 61 may extend in the direction (for example, the vertical direction Z) of the rotation axis of the outer door 200 with respect to the inner door 100.

The outer door upper shaft 61 may support an upper portion of the outer door 200. The outer door upper shaft 61 may be coupled to the upper portion of the outer door 200. For example, the outer door upper shaft 61 may be coupled to an upper portion of the second outer door frame 220.

The outer door upper shaft 61 may be coupled to the outer door 200 by being inserted into the outer door 200. The outer door 200 may include an outer door upper shaft hole 241 into which the outer door upper shaft 61 is inserted. For example, the outer door upper shaft hole 241 may be positioned in the upper portion of the outer door 200. For example, the outer door upper shaft hole 241 may be positioned in the rear side of the outer door 200. For example, the outer door upper shaft 61 may extend downward from an upper side of the outer door upper shaft hole 241 and be inserted into the outer door upper shaft hole 241. According to the outer door upper shaft 61 being inserted into the outer door upper shaft hole 241, the outer door upper shaft 61 may be coupled to the outer door 200 and rotatably support the outer door 200. For example, the outer door upper shaft 61 may be provided in the second outer door frame 220. At least a part of the upper shaft guide 260 described above may be inserted in the outer door upper shaft hole 241.

The outer door upper shaft 61 may be positioned adjacent to one side 202 of the outer door 200. The one side 202 of the outer door 200 may be one side (for example, a left side of the outer door 200 included in a left door or a right side of the outer door 200 included in a right door) adjacent to the outer door upper shaft 61 among both sides of the outer door 200 in a direction (for example, the left-right direction Y) that is perpendicular to an extension direction (for example, the vertical direction Z) of the outer door upper shaft 61. According to the outer door upper shaft 61 being positioned adjacent to the one side 202 of the outer door 200, the outer door 200 may be efficiently prevented from interfering with the inner door 100 while rotating with respect to the inner door 100.

According to an embodiment, the refrigerator 1 may include the outer door hinge bracket 70 that connects the upper portion of the outer door 200 to the upper portion of the inner door 100. The outer door hinge bracket 70 may be coupled to the upper portion of the inner door 100. The outer door hinge bracket 70 may be connected to the outer door upper shaft 61. The outer door hinge bracket 70 may be connected to the outer door upper shaft 61 and rotatably support the outer door 200.

According to an embodiment, the rotation axis of the inner door 100 and the rotation axis of the outer door 200 may be spaced apart from each other in the horizonal direction that is different from an extension direction of each rotation axis. The inner door upper shaft 51 and the outer door upper shaft 61 may be spaced apart from each other in the horizontal direction that is different from the extension direction of each shaft.

According to an embodiment, the inner door upper shaft 51 and the outer door upper shaft 61 may be spaced apart from each other in the vertical direction Z that is parallel to the rotation axis of each of the inner door 100 and the outer door 200. In various embodiments, the inner door upper shaft 51 and the outer door upper shaft 61 may be arranged adjacent to each other, and in a case where the inner door upper shaft 51 and the outer door upper shaft 61 have the same height in the vertical direction Z, an overall thickness of the inner door 100 and the outer door 200 may increase to avoid interference between the inner door upper shaft 51 and the outer door upper shaft 61. However, in an embodiment, because the inner door upper shaft 51 and the outer door upper shaft 61 are spaced apart from each other in the vertical direction Z, an overall thickness of the inner door 100 and the outer door 200 may be reduced while interference between the inner door upper shaft 51 and the outer door upper shaft 61 does not occur.

Although the inner door upper shaft 51 and the outer door upper shaft 61 are spaced apart from each other in the vertical direction Z to reduce an overall thickness of the door, as described above, there may be limitation in reducing an overall thickness of the inner door 100 and the outer door 200 unless the inner door 100 and the outer door 200 overlap each other. In this structure, a length of the outer door 200 protruding in the front direction may increase to prevent the outer door 200 from interfering with the inner door 100, and in this case, there may be high possibility that when the door is opened, the door will interfere with a cabinet where the refrigerator 1 is placed. In this case, to prevent interference with the cabinet, the refrigerator 1 may need to secure a large space from inner walls of the cabinet.

Hereinafter, an embodiment of the present disclosure having a structure for reducing an overall thickness of a door while preventing an inner door and an outer door from interfering with each other and preventing, when the door is opened, the door from interfering with a cabinet will be described in detail with reference to the drawings.

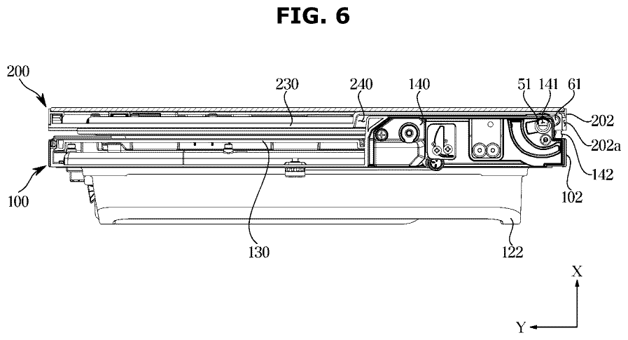

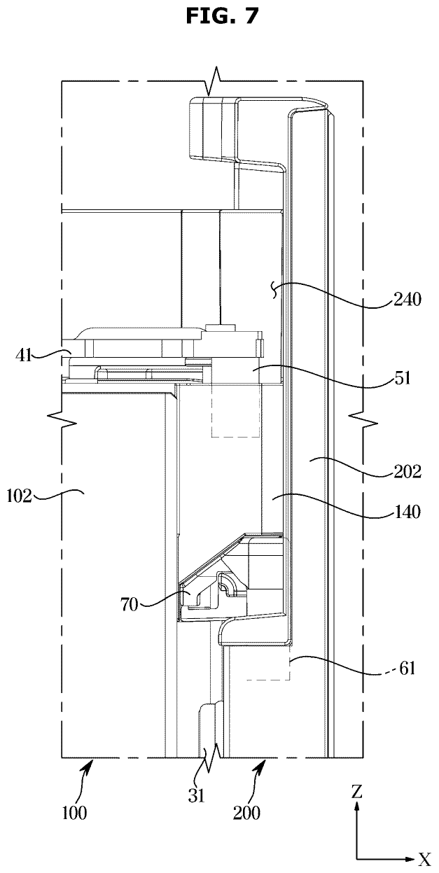

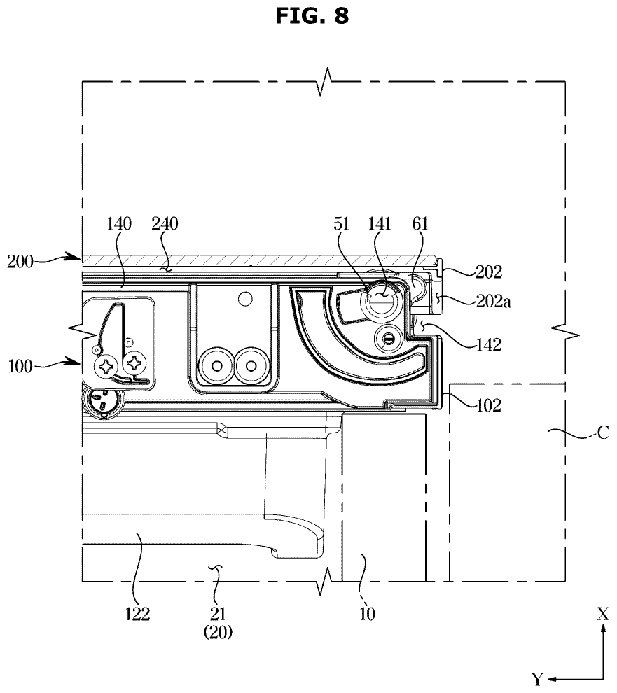

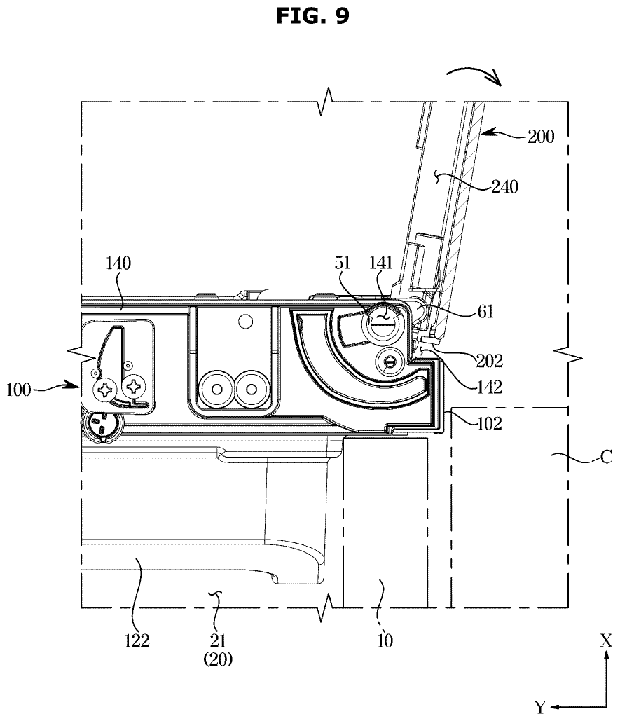

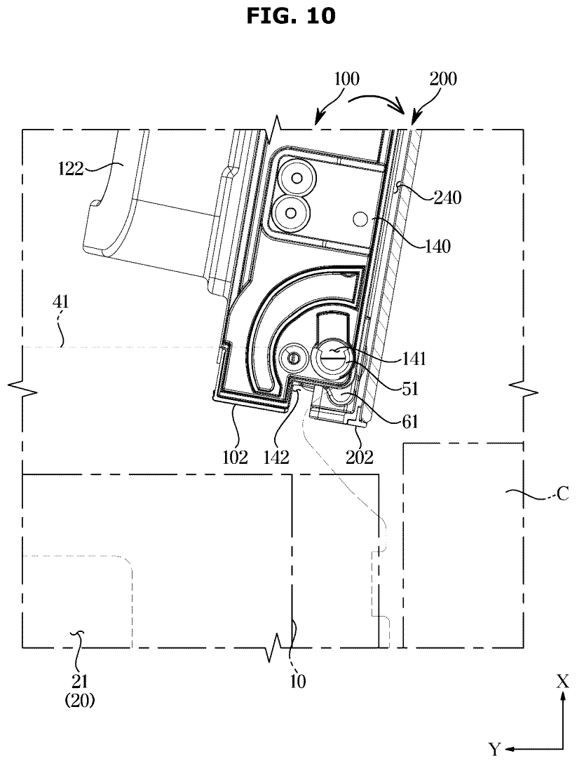

FIG. 6 is a top view showing some components, such as an inner door, an outer door, an upper hinge bracket, an inner door upper shaft, and an outer door upper shaft, of a refrigerator according to an embodiment of the present disclosure. FIG. 7 is an enlarged side view showing some components, such as an inner door, an outer door, an upper hinge bracket, an inner door upper shaft, and an outer door upper shaft, of a refrigerator according to an embodiment of the present disclosure. FIG. 8 is an enlarged top view showing some components, such as an inner door, an outer door, an inner door upper shaft, and an outer door upper shaft, of a refrigerator according to an embodiment of the present disclosure, wherein the outer door and the inner door are in a closed state. FIG. 9 is an enlarged top view showing some components, such as an inner door, an outer door, an inner door upper shaft, and an outer door upper shaft, of a refrigerator according to an embodiment of the present disclosure, wherein the outer door is opened with respect to the inner door. FIG. 10 is an enlarged top view showing some components, such as an inner door, an outer door, an inner door upper shaft, and an outer door upper shaft, of a refrigerator according to an embodiment of the present disclosure, wherein the outer door and the inner door are opened with respect to a main body.

Referring to FIGS. 6 to 10, the inner door 100 and the outer door 200 of the refrigerator 1 according to an embodiment of the present disclosure may overlap each other in some parts while the outer door 200 is closed with respect to the inner door 100 (that is, while the outer door 200 covers the inner door 100).

According to an embodiment, the inner door 100 may include an inner door panel portion 130, and an inner door protrusion (for example, the inner door upper protrusion 140 or the inner door lower protrusion 150 (see FIG. 11)) protruding from the inner door panel portion 130.

The inner door upper protrusion 140 of the inner door protrusion will be described with reference to FIGS. 6 to 10. The inner door upper protrusion 140 may protrude from at least an upper portion of the inner door panel portion 130. For example, the inner door upper protrusion 140 may be provided in at least an upper portion of the first inner door frame 110.

The inner door upper protrusion 140 may protrude from the inner door panel portion 130 toward the outer door 200. The inner door upper protrusion 140 may protrude forward from the inner door panel portion 130.

For example, the inner door panel portion 130 may have a substantially uniform thickness. For example, a part of the inner door 100 on which only the inner door panel portion 130 is provided may be thinner than another part of the inner door 100 on which the inner door upper protrusion 140 is positioned.

The inner door panel portion 130 may be positioned relatively far from the rotation axis of the inner door 100, and the inner door upper protrusion 140 may be positioned relatively close to the rotation axis of the inner door 100. The inner door panel portion 130 may be positioned relatively far from the inner door upper shaft 51, and the inner door upper protrusion 140 may be positioned relatively close to the inner door upper shaft 51.

According to an embodiment, the rotation axis of the inner door 100 may pass through the inner door upper protrusion 140. The inner door upper shaft 51 may be positioned in the inner door upper protrusion 140. The inner door upper shaft 51 may be coupled to the inner door upper protrusion 140.

The inner door upper protrusion 140 may include the inner door upper shaft hole 141 to which the inner door upper shaft 51 is coupled. The inner door upper shaft hole 141 may be formed in one side of the inner door upper protrusion 140. For example, the inner door upper shaft hole 141 may be formed in one side of the inner door upper protrusion 140, which is opposite to the outer door upper shaft 61. For example, the inner door upper shaft hole 141 may be formed in an upper side of the inner door upper protrusion 140.

According to an embodiment, the outer door 200 may include an outer door panel portion 230, and an outer door groove (for example, the outer door upper groove 240 or the outer door lower groove 250 (see FIG. 11)) recessed from a rear side of the outer door panel portion 230.

The outer door upper groove 240 of the outer door groove will be described with reference to FIGS. 6 to 10. The outer door upper groove 240 may be recessed from at least an upper portion of the rear side of the outer door panel portion 230. For example, the outer door upper groove 240 may be provided in at least an upper portion of the second outer door frame 220.

While the outer door 200 is closed with respect to the inner door 100, the outer door panel portion 230 may face the inner door panel portion 130. While the outer door 200 is closed with respect to the inner door 100, the outer door upper groove 240 may face the inner door upper protrusion 140.

The outer door upper groove 240 may be recessed from the outer door panel portion 230 in a direction of being far away from the inner door 100. The outer door upper groove 240 may be recessed forward from the outer door panel portion 230.

For example, the outer door panel portion 230 may have a substantially uniform thickness. For example, the outer door panel portion 230 may have a substantially flat plate shape. For example, a part of the outer door 200 on which only the outer door panel portion 230 is provided may be thicker than another part of the outer door 200 in which the outer door upper groove 240 is positioned.

The outer door panel portion 230 may be positioned relatively far from the rotation axis of the outer door 200, and the outer door upper groove 240 may be positioned relatively close to the rotation axis of the outer door 200. The outer door panel portion 230 may be positioned relatively far from the outer door upper shaft 61, and the outer door upper groove 240 may be positioned relatively close to the outer door upper shaft 61.

According to an embodiment, the rotation axis of the outer door 200 may pass through the outer door upper groove 240. The outer door upper shaft 61 may be positioned in the outer door upper groove 240. The outer door upper shaft 61 may be coupled to an inner wall of the outer door upper groove 240, which surrounds the outer door upper groove 240.

The outer door upper groove 240 may include the outer door upper shaft hole 241 to which the outer door upper shaft 61 is coupled. The outer door upper shaft hole 241 may be formed in one side of the outer door upper groove 240. The outer door shaft hole 241 may be formed in an inner wall of the outer door upper groove 240. For example, the outer door upper shaft hole 241 may be formed in a lower side of the outer door upper groove 240.

The upper shaft guide 260 described above may be coupled to the inner wall of the outer door upper groove 240. The upper shaft guide 260 may be inserted into the outer door upper shaft hole 241.

The inner door upper protrusion 140 may be accommodated in the outer door upper groove 240. While the outer door 200 is closed with respect to the inner door 100, the inner door upper protrusion 140 may be accommodated in the outer door upper groove 240. The inner door upper shaft 51 coupled to the inner door upper protrusion 140 may also be accommodated in the outer door upper groove 240.

According to the inner door upper protrusion 140 being accommodatable in the outer door upper groove 240, while the outer door 200 is closed with respect to the inner door 100, the outer door 200 may be prevented from interfering with the inner door 100, while reducing an overall thickness of the door. Because the overall thickness of the door is reduced, while the door is opened as shown in FIG. 10, interference between the door and a cabinet C may be efficiently reduced and/or prevented. Therefore, it may be possible to reduce spaces between the refrigerator 1 and inner walls of the cabinet C.

While the outer door 200 and the inner door 100 are closed, the outer door upper groove 240 may accommodate a part of the upper hinge bracket 41. While the outer door 200 and the inner door 100 are closed, the outer door upper groove 240 may accommodate at least a part of the upper hinge bracket 41, which is coupled to the inner door upper shaft 51. Therefore, the outer door 200 may be prevented from interfering with the upper hinge bracket 41.

While the outer door 200 and the inner door 100 are closed, the outer door upper groove 240 may accommodate a part of the top table 19. While the outer door 200 and the inner door 100 are closed, the outer door upper groove 240 may accommodate a part of the top table 19 which covers at least the inner door upper shaft 51. Therefore, the outer door 200 may be prevented from interfering with the top table 19.

According to an embodiment, because both the inner door upper shaft 51 and the outer door upper shaft 61 are positioned in the outer door upper groove 240, the inner door upper shaft 51 and the outer door upper shaft 61 may be spaced apart from each other in the vertical direction Z which is the extension direction of each of the inner door upper shaft 51 and the outer door upper shaft 61 to be prevented from interfering with each other, while reducing a thickness of the outer door 200.

For example, the inner door upper shaft 51 may be positioned closer to an edge of the outer door 200 in the vertical direction Z than the outer door upper shaft 61. The inner door upper shaft 51 may be positioned more outward in the vertical direction Z of the outer door 200 than the outer door upper shaft 61. The inner door upper shaft 51 may be positioned above the outer door upper shaft 61. The inner door upper shaft hole 141 may be positioned above the outer door upper shaft hole 241.

For example, the outer door upper shaft 61 may be positioned below the inner door upper protrusion 140. The outer door upper shaft 61 may be coupled to a lower portion of the outer door upper groove 240. The outer door upper shaft hole 241 may be positioned below the inner door upper protrusion 140. The outer door upper shaft hole 241 may be positioned below the outer door upper groove 240.

For example, the inner door upper protrusion 140 may be positioned between the upper hinge bracket 41 and the outer door upper shaft 61 in a direction (for example, the vertical direction Z) that is parallel to the rotation axis of each of the inner door 100 and the outer door 200.

According to an embodiment, the outer door 200 may include the side upper groove 202a formed in the one side 202 of the outer door 200. The one side 202 of the outer door 200 may be one side of the outer door 200 adjacent to the outer door upper shaft 61 among both sides of the outer door 200 in a direction (for example, the left-right direction Y) that is perpendicular to the extension direction (for example, the vertical direction Z) of the outer door upper shaft 61. The side upper groove 202a may be formed in the one side 202 of the outer door 200 by being recessed from the rear side of the outer door 200 toward the front side of the outer door 200. A part of the outer door 200, in which the side upper groove 202a is formed, may have a smaller width in the front-rear direction X than the other part of the outer door 200. The side upper groove 202a may be formed in an upper portion of the one side 202 of the outer door 200.

The side upper groove 202a may be connected to the outer door upper groove 240.

According to the side upper groove 202a being formed in the one side 202 of the outer door 200, while the outer door 200 is opened, interference between the outer door 200 and other structures, such as the inner door 100, the upper hinge bracket 41, the top table 19, etc., may be efficiently reduced and/or prevented.

The inner door upper protrusion 140 may include the inner door upper groove 142 formed in the one side 102 of the inner door upper protrusion 140. The one side 102 of the inner door upper protrusion 140 may be one side of the inner door upper protrusion 140 adjacent to the inner door upper shaft 51 among both sides of the inner door upper protrusion 140 in the direction (for example, the left-right direction Y) that is perpendicular to the extension direction (for example, the vertical direction Z) of the inner door upper shaft 51. The inner door upper groove 142 may be recessed from the one side 102 of the inner door upper protrusion 140. For example, the inner door upper groove 142 may be recessed from the one side 102 of the inner door upper protrusion 140 toward another side that is opposite to the one side 102.

The inner door upper groove 142 may be recessed to prevent interference caused by a rotation of the outer door 200. For example, while the outer door 200 is opened to a preset angle or more with respect to the inner door 100 (see FIG. 9), a part of the outer door 200 adjacent to the outer door upper shaft 61 may be positioned in the inner door upper groove 142.

For example, a part of the inner door upper groove 142 may overlap a part of the outer door upper groove 240.

According to the inner door upper groove 142 being formed in the one side 102 of the inner door upper protrusion 140, while the outer door 200 is opened with respect to the inner door 100, interference between the outer door 200 and the inner door 100 may be efficiently reduced and/or prevented.

For example, the inner door upper groove 142 may extend from a front side of the inner door upper protrusion 140 toward a rear side of the inner door upper protrusion 140.

By this structure, in an embodiment of the present disclosure, interference between the inner door 100 and the outer door 200 may be prevented while an overall thickness of the door may be reduced. Also, while the door is opened, the door may be efficiently prevented from interfering with a surrounding object such as a cabinet C.

FIG. 11 is an enlarged perspective view showing some components, such as an inner door, an outer door, a lower hinge bracket, an inner door lower shaft, and an outer door lower shaft, of a refrigerator according to an embodiment of the present disclosure.

A door shaft and a hinge bracket coupled to the inner door 100 and the outer door 200 according to an embodiment of the present disclosure will be described with reference to FIG. 11.

According to an embodiment, the refrigerator 1 may include the inner lower shaft 52 that rotatably supports the inner door 100 with respect to the main body 10. The inner door 100 may rotate on the inner door lower shaft 52. The inner door lower shaft 52 may extend in the direction (for example, the vertical direction Z) of the rotation axis of the inner door 100 with respect to the main body 10. The inner door lower shaft 52 may be positioned in the vertical direction Z that is perpendicular to the inner door upper shaft 51.

The inner door lower shaft 52 may support a lower portion of the inner door 100. The inner door lower shaft 52 may be coupled to the lower portion of the inner door 100. For example, the inner door lower shaft 52 may be coupled to a lower portion of the first inner door frame 110.

The inner door 100 may include the inner door lower shaft hole 151 in which the inner door lower shaft 52 is inserted. For example, the inner door lower shaft hole 151 may be positioned at a lower side of the inner door 100. For example, the inner door lower shaft 52 may extend upward from a lower side of the inner door lower shaft hole 151 and be inserted into the inner door lower shaft hole 151. According to the inner door lower shaft 52 being inserted in the inner door lower shaft hole 151, the inner door lower shaft 52 may be coupled to the inner door 100 and rotatably support the inner door 100. For example, the inner door lower shaft hole 151 may be provided in the first inner door frame 110.

The inner door lower shaft 52 may be positioned adjacent to the one side 102 of the inner door 100. The one side 102 of the inner door 100 may be one side (for example, a left side of the inner door 100 included in a left door or a right side of the inner door 100 included in a right door) of the inner door 100 adjacent to the inner door lower shaft 52 among both sides of the inner door 100 in a direction (for example, the left-right direction Y) that is perpendicular to the extension direction (for example, the vertical direction Z) of the inner door lower shaft 52.

According to an embodiment, the refrigerator 1 may include the lower hinge bracket 42 that connects the lower portion of the inner door 100 to a lower portion of the main body 10. The lower hinge bracket 42 may be coupled to the lower portion of the main body 10. The lower hinge bracket 42 may be connected to the inner door lower shaft 52. The lower hinge bracket 42 may be connected to the inner door lower shaft 52 and rotatably support the inner door 100.

For example, the lower hinge bracket 42 may include a hinge cam 42a, and the inner door lower shaft 52 may include a door cam 52a engaged with the hinge cam 42a. The hinge cam 42a may be provided on an upper surface of the lower hinge bracket 42. The door cam 52a may be provided on a lower surface of the inner door lower shaft 52. While the inner door 100 rotates with respect to the main body 10, the door cam 52a may move along the hinge cam 42a to guide opening or closing of the inner door 100.

According to an embodiment, the refrigerator 1 may include the outer door lower shaft 62 that rotatably supports the outer door 200 with respect to the inner door 100. The outer door 200 may rotate on the outer door lower shaft 62. The outer door lower shaft 62 may extend in the direction (for example, the vertical direction Z) of the rotation axis of the outer door 200 with respect to the inner door 100.

The outer door lower shaft 62 may support a lower portion of the outer door 200. The outer door lower shaft 62 may be coupled to the lower portion of the outer door 200. For example, the outer door lower shaft 62 may be coupled to a lower portion of the second outer door frame 220. For example, the outer door lower shaft 62 may be coupled to the outer door 200 by being inserted into the outer door 200.

The outer door lower shaft 62 may be positioned adjacent to the one side 202 of the outer door 200. The one side 202 of the outer door 200 may be one side (for example, a left side of the outer door 200 included in a left door or a right side of the outer door 200 included in a right door) of the outer door 200 adjacent to the outer door upper shaft 61 among both sides of the outer door 200 in a direction (for example, the left-right direction Y) that is perpendicular to the extension direction (for example, the vertical direction Z) of the outer door upper shaft 61.

According to an embodiment, the outer door lower shaft 62 may be coupled to the lower portion of the inner door 100. For example, the outer door lower shaft 62 may be coupled to the inner door lower protrusion 150 of the inner door 100, which will be described below.

According to an embodiment, the outer door 200 may include the lower shaft guide 270 to which the outer door lower shaft 62 is coupled. The outer door lower shaft 62 may be inserted in the lower shaft guide 270. The lower shaft guide 270 may be coupled to the second outer door frame 220.

According to an embodiment, the inner door lower shaft 52 and the outer door lower shaft 62 may be spaced apart from each other in the horizontal direction that is different from the extension direction of each of the inner door lower shaft 52 and the outer door lower shaft 62.

According to an embodiment, the inner door lower shaft 52 and the outer door lower shaft 62 may be spaced apart from each other in the vertical direction Z that is parallel to the rotation axis of each of the inner door 100 and the outer door 200. Because the inner door lower shaft 52 and the outer door lower shaft 62 are spaced apart from each other in the vertical direction Z, the inner door lower shaft 52 and the outer door lower shaft 62 may be prevented from interfering with each other while reducing an overall thickness of the inner door 100 and the outer door 200.

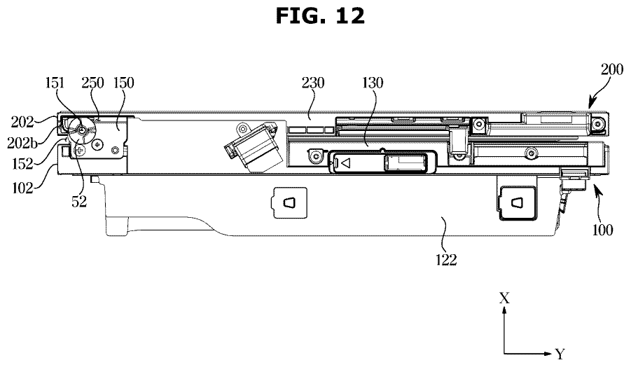

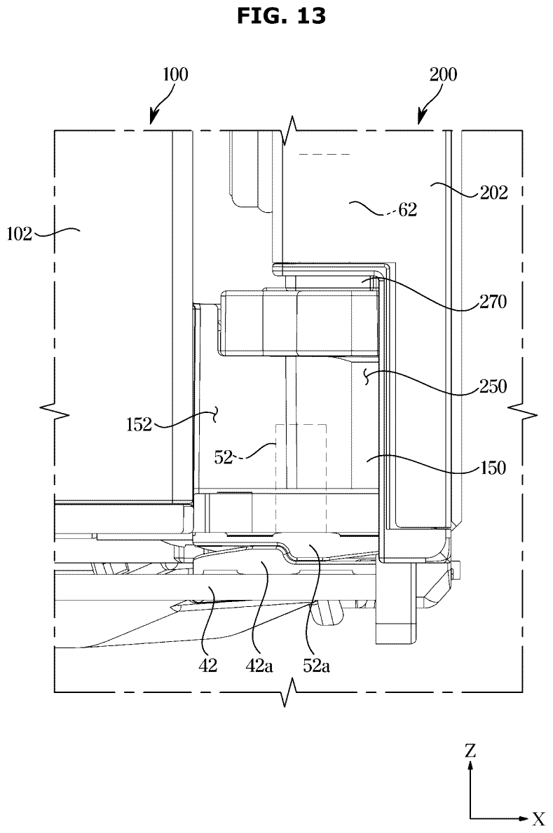

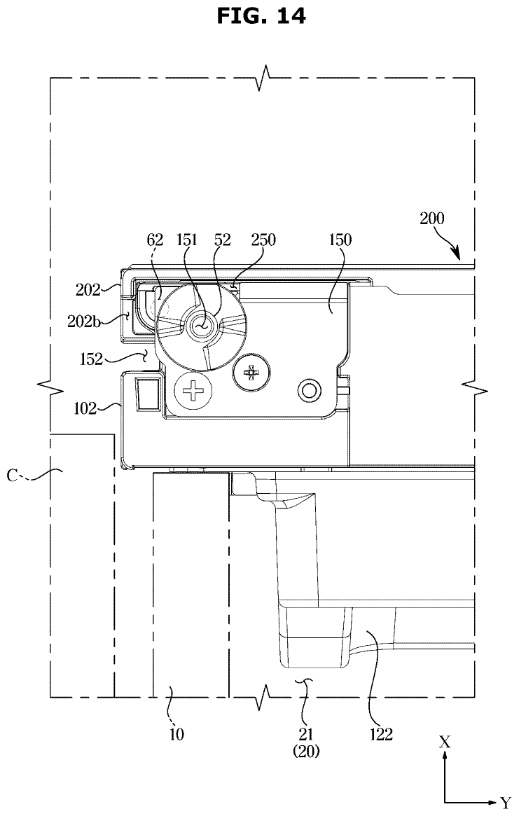

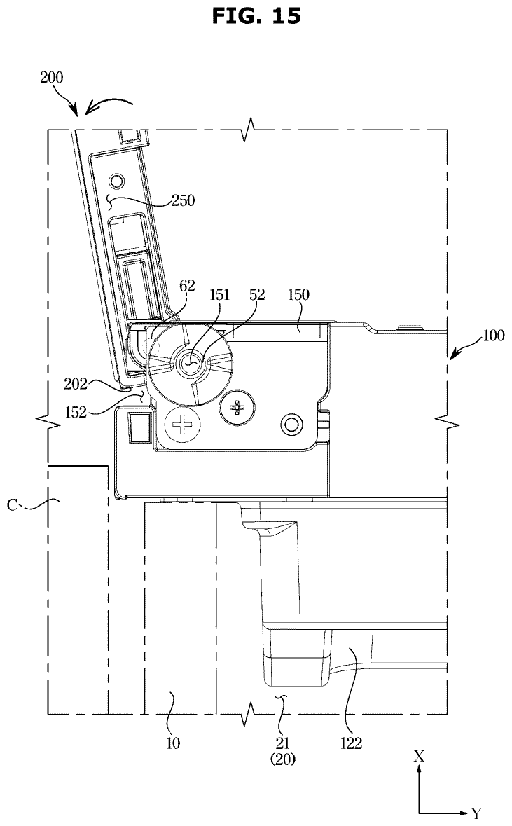

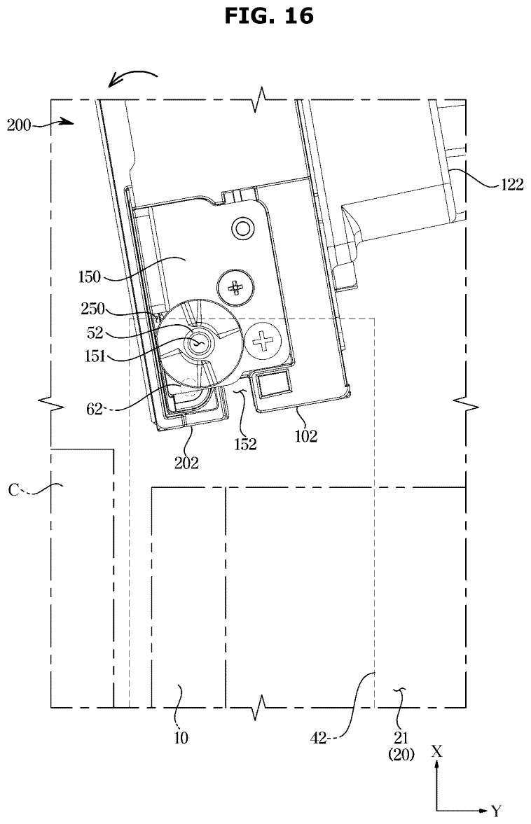

FIG. 12 is a bottom view showing some components, such as an inner door, an outer door, an inner door lower shaft, and an outer door lower shaft, of a refrigerator according to an embodiment of the present disclosure. FIG. 13 is an enlarged side view showing some components, such as an inner door, an outer door, a lower hinge bracket, an inner door lower shaft, and an outer door lower shaft, of a refrigerator according to an embodiment of the present disclosure. FIG. 14 is an enlarged bottom view showing some components, such as an inner door, an outer door, an inner door lower shaft, and an outer door lower shaft, of a refrigerator according to an embodiment of the present disclosure, wherein the outer door and the inner door are in a closed state. FIG. 15 is an enlarged bottom view showing some components, such as an inner door, an outer door, an inner door lower shaft, and an outer door lower shaft, of a refrigerator according to an embodiment of the present disclosure, wherein the outer door is opened with respect to the inner door. FIG. 16 is an enlarged bottom view showing some components, such as an inner door, an outer door, an inner door lower shaft, and an outer door lower shaft, of a refrigerator according to an embodiment of the present disclosure, wherein the outer door and the inner door are opened with respect to a main body.

Referring to FIGS. 12 to 16, the inner door 100 and the outer door 200 of the refrigerator 1 according to an embodiment of the present disclosure may overlap each other in some parts while the outer door 200 is closed with respect to the inner door 100 (that is, while the outer door 200 covers the inner door 100).

The inner door lower protrusion 150 of the inner door protrusion will be described with reference to FIGS. 12 to 16. The inner door lower protrusion 150 may protrude from at least a lower portion of the inner door panel portion 130. For example, the inner door lower protrusion 150 may be provided in at least a lower portion of the first inner door frame 110. For example, the inner door lower protrusion 150 may be aligned with the inner door upper protrusion 140 in the horizontal direction.

The inner door lower protrusion 150 may protrude from the inner door panel portion 130 toward the outer door 200. The inner door lower protrusion 150 may protrude forward from the inner door panel portion 130.

For example, a part of the inner door 100 on which only the inner door panel portion 130 is provided may be thinner than another part of the inner door 100 on which the inner door lower protrusion 150 is provided.

The inner door panel portion 130 may be positioned relatively far from the rotation axis of the inner door 100, and the inner door lower protrusion 150 may be positioned relatively close to the rotation axis of the inner door 100. The inner door panel portion 130 may be positioned relatively far from the inner door upper shaft 51, and the inner door lower protrusion 150 may be positioned relatively close to the inner door upper shaft 51.

According to an embodiment, the rotation axis of the inner door 100 may pass through the inner door lower protrusion 150. The inner door lower shaft 52 may be positioned in the inner door lower protrusion 150. The inner door lower shaft 52 may be coupled to the inner door lower protrusion 150.

The inner door lower protrusion 150 may include the inner door lower shaft hole 151 to which the inner door lower shaft 52 is coupled. The inner door lower shaft hole 151 may be formed in one side of the inner door lower protrusion 150. For example, the inner door lower shaft hole 151 may be formed in one side of the inner door lower protrusion 150, which is opposite to the outer door lower shaft 62. For example, the inner door lower shaft hole 151 may be formed in a lower side of the inner door lower protrusion 150.

The outer door lower groove 250 of the outer door groove will be described with reference to FIGS. 12 to 16. The outer door lower groove 250 may be recessed from at least a lower part of a rear side of the outer door panel portion 230. For example, the outer door lower groove 250 may be provided in at least a rear portion of the second outer door frame 220. For example, the outer door lower groove 250 may be aligned with the outer door upper groove 240 in the vertical direction Z.

While the outer door 200 is closed with respect to the inner door 100, the outer door lower groove 250 may face the inner door lower protrusion 150.

The outer door lower groove 250 may be recessed from the outer door panel portion 230 in a direction of being far away from the inner door 100. The outer door lower groove 250 may be recessed forward from the outer door panel portion 230.

For example, a part of the outer door 200 on which only the outer door panel portion 230 is provided may be thicker than another part of the outer door in which the outer door lower groove 250 is provided.

The outer door panel portion 230 may be positioned relatively far from the rotation axis of the outer door 200, and the outer door lower groove 250 may be positioned relatively close to the rotation axis of the outer door 200. The outer door panel portion 230 may be positioned relatively far from the outer door lower shaft 62, and the outer door lower groove 250 may be positioned relatively close to the outer door lower shaft 62.

According to an embodiment, the rotation axis of the outer door 200 may pass through the outer door lower groove 250. The outer door lower shaft 62 may be positioned in the outer door lower groove 250. The outer door lower shaft 62 may be coupled to an inner wall of the outer door lower groove 250, surrounding the outer door lower groove 250. For example, the outer door lower shaft 62 may be inserted in the inner wall of the outer door lower groove 250. For example, the outer door lower shaft 62 may be formed on a lower surface of the outer door lower groove 250.

The lower shaft guide 270 described above may be coupled to the inner wall of the outer door lower groove 250. The lower shaft guide 270 may be coupled to a lower portion of the outer door lower groove 250.

The inner door lower protrusion 150 may be accommodated in the outer door lower groove 250. While the outer door 200 is closed with respect to the inner door 100, the inner door lower protrusion 150 may be accommodated in the outer door lower groove 250. The inner door lower shaft 52 coupled to the inner door lower protrusion 150 may also be accommodated in the outer door lower groove 250.

According to the inner door lower protrusion 150 being accommodatable in the outer door lower groove 250, while the outer door 200 is closed with respect to the inner door 100, the outer door 200 may be prevented from interfering with the inner door 100, while reducing an overall thickness of the door. Because the overall thickness of the door is reduced, while the door is opened as shown in FIG. 16, interference between the door and a cabinet C may be efficiently reduced and/or prevented. Therefore, it may be possible to reduce spaces between the refrigerator 1 and inner walls of the cabinet C.

While the outer door 200 and the inner door 100 are closed, the outer door lower groove 250 may accommodate a part of the lower hinge bracket 42. While the outer door 200 and the inner door 100 are closed, the outer door lower groove 250 may accommodate at least a part of the lower hinge bracket 42 which is coupled to the inner door lower shaft 52. Therefore, the outer door 200 may be prevented from interfering with the lower hinge bracket 41.

According to an embodiment, because both the inner door lower shaft 52 and the outer door lower shaft 62 are positioned in the outer door lower groove 250, the inner door lower shaft 52 and the outer door lower shaft 62 may be spaced apart from each other in the vertical direction Z which is the extension direction of each of the inner door lower shaft 52 and the outer door lower shaft 62 to be prevented from interfering with each other, while reducing a thickness of the outer door 200.

For example, the inner door lower shaft 52 may be positioned closer to an edge of the outer door 200 in the vertical direction Z than the outer door lower shaft 62. The inner door lower shaft 52 may be positioned more outward in the vertical direction Z of the outer door 200 than the outer door lower shaft 62. The inner door lower shaft 52 may be positioned below the outer door lower shaft 62.

For example, the outer door lower shaft 62 may be positioned above the inner door lower protrusion 150. The outer door lower shaft 62 may be coupled to an upper portion of the outer door lower groove 250.

For example, the inner door lower protrusion 150 may be positioned between the lower hinge bracket 42 and the outer door lower shaft 62 in the direction (for example, the vertical direction Z) that is parallel to the rotation axis of each of the inner door 100 and the outer door 200.

According to an embodiment, the outer door 200 may include the side lower groove 202b formed in the one side 202 of the outer door 200. The one side 202 of the outer door 200 may be one side of the outer door 200 adjacent to the outer door lower shaft 62 among both sides of the outer door 200 in a direction (for example, the left-right direction Y) that is perpendicular to the extension direction (for example, the vertical direction Z) of the outer door lower shaft 62. The side lower groove 202b formed in the one side 202 of the outer door 200 may be recessed from the rear side of the outer door 200 toward the front side of the outer door 200. A part of the outer door 200, in which the side lower groove 202b is formed, may have a smaller width in the front-rear direction X than the other part of the outer door 200. The side lower groove 202b may be formed in a lower portion of the one side 202 of the outer door 200.

The side lower groove 202b may be connected to the outer door lower groove 250.

According to the side lower groove 202b being formed in the one side 202 of the outer door 200, while the outer door 200 is opened, interference between the outer door 200 and other structures, such as the inner door 100, the lower hinge bracket 42, etc., may be efficiently reduced and/or prevented.

The inner door lower protrusion 150 may include the inner door lower groove 152 formed in the one side 102 of the inner door lower protrusion 150. The one side 102 of the inner door lower protrusion 150 may be one side of the inner door lower protrusion 150 adjacent to the inner door lower shaft 52 among both sides of the inner door lower protrusion 150 in a direction (for example, the left-right direction Y) that is perpendicular to the extension direction (for example, the vertical direction Z) of the inner door lower shaft 52. The inner door lower groove 152 may be recessed from the one side 102 of the inner door lower protrusion 150. For example, the inner door lower groove 152 may be recessed from the one side 102 of the inner door lower protrusion 150 toward another side that is opposite to the one side 102.

The inner door lower groove 152 may be recessed to prevent interference caused by a rotation of the outer door 200. For example, while the outer door 200 is opened to a preset angle or more with respect to the inner door 100 (see FIG. 9), a part of the outer door 200 adjacent to the outer door lower shaft 62 may be positioned in the inner door lower groove 152.

For example, a part of the inner door lower groove 152 may overlap a part of the outer door lower groove 250.

According to the inner door lower groove 152 being formed in the one side 102 of the inner door lower protrusion 150, while the outer door 200 is opened with respect to the inner door 100, interference between the outer door 200 and the inner door 100 may be efficiently reduced and/or prevented.

By this structure, in an embodiment of the present disclosure, interference between the inner door 100 and the outer door 200 may be prevented while an overall thickness of the door may be reduced. Also, while the door is opened, the door may be efficiently prevented from interfering with a surrounding object such as a cabinet C.

According to an embodiment of the present disclosure, a refrigerator may include a main body forming a storage room, an inner door configured to rotate with respect to the main body, an outer door configured to rotate with respect to the inner door, an inner door shaft rotatably supporting the inner door with respect to the main body, and an outer door shaft rotatably supporting the outer door with respect to the inner door. The inner door may include an inner door panel portion, and an inner door protrusion protruding from the inner door panel portion toward the outer door and coupled to the inner door shaft. The outer door may include an outer door panel portion facing the inner door panel portion while the outer door is closed with respect to the inner door, and an outer door groove on a rear side of the outer door panel portion. The outer door shaft may be positioned in the outer door groove. The inner door protrusion, the inner door shaft, and the outer door groove may be configured such that, while the outer door is closed with respect to the inner door, the inner door protrusion and the inner door shaft are may be accommodated in the outer door groove.

The outer door shaft and the inner door shaft may be vertically spaced apart from each other in a direction parallel to a rotation axis of each of the inner door and the outer door.

The inner door shaft may be closer to an edge of the outer door in the vertical direction than the outer door shaft.

A central axis of the outer door shaft and a central axis of the inner door shaft may be spaced apart from each other in a horizontal direction that is perpendicular to a rotation axis of the inner door.

The outer door may further include a side groove recessed from a rear side of the outer door toward a front side that is opposite to the rear side, in one side adjacent to the outer door shaft among both sides of the outer door in a direction that is perpendicular to an extension direction of the outer door shaft.

The side groove may be connected to the outer door groove.

The inner door protrusion may include an inner door groove recessed to prevent interference caused by a rotation of the outer door, in one side adjacent to the inner door shaft among both sides of the inner door protrusion in a direction that is perpendicular to an extension direction of the inner door shaft.

The inner door groove may extend from a front side of the inner door protrusion toward a rear side that is opposite to the front side.

While the outer door being is opened to a preset angle or more with respect to the inner door, a part of the outer door adjacent to the outer door upper shaft may be accommodated in the inner door groove.

A portion of the inner door groove may overlap a portion of the outer door groove.

The inner door protrusion may include an inner door shaft hole to which the inner door shaft is coupled. The inner door shaft hole may be formed in one side of the inner door protrusion, which is spaced from the outer door shaft.

The refrigerator may further include a hinge bracket connecting the inner door shaft to the main body. The inner door protrusion may be positioned between the hinge bracket and the outer door shaft in a direction that is parallel to a rotation axis of each of the inner door and the outer door.

The refrigerator may further include a hinge bracket connecting the inner door shaft to the main body. While the outer door is closed with respect to the inner door, a part of the hinge bracket may be configured to be accommodated in the outer door groove.

The outer door shaft may be coupled to an inner wall of the outer door groove.

The outer door shaft may be supported by the inner door protrusion.

According to an embodiment of the present disclosure, a refrigerator may include a main body forming a storage room, a hinge bracket fixed to the main body, an inner door configured to rotate with respect to the hinge bracket, an outer door configured to rotate with respect to the inner door, an inner door shaft connecting the hinge bracket to the inner door, and an outer door shaft connecting the inner door to the outer door. The inner door may include an inner door panel portion, and an inner door protrusion protruding from the inner door panel portion toward the outer door. The outer door may include an outer door panel portion facing the inner door panel portion while the outer door is closed with respect to the inner door, and an outer door groove on a rear side of the outer door panel portion and configured to accommodate the inner door protrusion while the outer door covers the inner door. The inner door shaft may be coupled to the inner door protrusion. The outer door shaft may be coupled to an inner wall of the outer door groove.

The outer door shaft and the inner door shaft may be vertically spaced apart from each other in a direction parallel to a rotation axis of each of the inner door and the outer door.

The inner door protrusion may include an inner door groove recessed to prevent interference caused by a rotation of the outer door, in one side adjacent to the inner door shaft among both sides of the inner door protrusion in a direction that is perpendicular to an extension direction of the inner door shaft.

According to an embodiment of the present disclosure, a refrigerator may include a main body forming a storage room, an inner door configured to rotate with respect to the main body, an outer door configured to rotate with respect to the inner door, an inner door upper shaft rotatably supporting an upper portion of the inner door with respect to the main body, an inner door lower shaft rotatably supporting a lower portion of the inner door with respect to the main body, an outer door upper shaft spaced in a vertical direction from the inner door upper shaft and rotatably supporting an upper portion of the outer door with respect to the inner door, and an outer door lower shaft spaced in the vertical direction from the inner door lower shaft and configured to rotatably support a lower portion of the outer door with respect to the inner door. The inner door may include an inner door panel portion, an inner door upper protrusion protruding from an upper portion of the inner door panel portion. The inner door upper shaft may be coupled to the inner door upper protrusion. The inner door may further include an inner door lower protrusion protruding from a lower portion of the inner door panel portion. The inner door lower shaft may be coupled to the inner door lower protrusion. The outer door may include an outer door panel portion, an outer door upper groove on a rear side of an upper portion of the outer door panel portion. The outer door upper shaft may be positioned in the outer door upper groove. The outer door may further include an outer door lower groove on a rear side of a lower portion of the outer door panel portion. The outer door lower shaft may be positioned in the outer door lower groove. While the outer door is closed with respect to the inner door, the inner door upper protrusion and the inner door upper shaft may be accommodated in the outer door upper groove, and the inner door lower protrusion and the inner door lower shaft may be accommodated in the outer door lower groove.

The inner door upper shaft may be positioned above the outer door upper shaft. The inner door upper shaft may be positioned below the outer door upper shaft.

According to a concept of the present disclosure, the inner door may include the inner door protrusion where the inner door shaft is positioned, the outer door may include the outer door groove where the outer door shaft is positioned, and the inner door protrusion may be inserted into the outer door groove to reduce an overall thickness of the door.

According to a concept of the present disclosure, the inner door shaft and the outer door shaft may be spaced apart from each other in the vertical direction to be prevented from interfering with each other while reducing an overall thickness of the door.

According to a concept of the present disclosure, because an overall thickness of the inner door and the outer door is reduced, interference between the door and a surrounding object such as a cabinet may be reduced and/or prevented.

According to a concept of the present disclosure, while the outer door is closed with respect to the inner door, the inner door protrusion may be accommodated in the outer door groove, thereby reducing and/or preventing interference between the inner door and the outer door.

According to a concept of the present disclosure, because the outer door has the side groove provided in one side of the outer door, interference between the outer door and the inner door may be reduced and/or prevented while the outer door is opened.

According to a concept of the present disclosure, because the inner door has the inner door groove provided in one side of the inner door protrusion, interference between the outer door and the inner door may be reduced and/or prevented while the outer door is opened.

Effects that may be achieved by the concepts of the present disclosure are not limited to the above-mentioned effects, and other effects not mentioned will be clearly understood by one of ordinary skill in the technical field to which the present disclosure belongs from the following descriptions.

So far, specific embodiments have been shown and described. However, the present disclosure is not limited to the above-described embodiments, and various modifications can be made by those skilled in the technical art to which the present disclosure belongs without departing from the gist of the technical idea of the present disclosure defined by the claims below.

1. A refrigerator comprising:
a main body forming a storage room;
an inner door configured to rotate with respect to the main body;
an outer door configured to rotate with respect to the inner door;
an inner door shaft rotatably supporting the inner door with respect to the main body; and
an outer door shaft rotatably supporting the outer door with respect to the inner door,
wherein the inner door includes:
an inner door panel portion, and
an inner door protrusion protruding from the inner door panel portion toward the outer door and coupled to the inner door shaft,
wherein the outer door includes:
an outer door panel portion facing the inner door panel portion while the outer door is closed with respect to the inner door, and
an outer door groove on a rear side of the outer door panel portion,
wherein the outer door shaft is positioned in the outer door groove, and
wherein the inner door protrusion, the inner door shaft, and the outer door groove are configured such that, while the outer door is closed with respect to the inner door, the inner door protrusion and the inner door shaft are accommodated in the outer door groove.

2. The refrigerator of claim 1, wherein:
the outer door shaft and the inner door shaft are vertically spaced apart from each other in a direction parallel to a rotation axis of each of the inner door and the outer door.

3. The refrigerator of claim 2, wherein:
the inner door shaft is closer to an edge of the outer door in the vertical direction than the outer door shaft.

4. The refrigerator of claim 1, wherein:
a central axis of the outer door shaft and a central axis of the inner door shaft are spaced apart from each other in a horizontal direction that is perpendicular to a rotation axis of the inner door.

5. The refrigerator of claim 1, wherein:
the outer door further includes a side groove recessed from a rear side of the outer door toward a front side that is opposite to the rear side, in one side adjacent to the outer door shaft among both sides of the outer door in a direction that is perpendicular to an extension direction of the outer door shaft.

6. The refrigerator of claim 5, wherein:
the side groove is connected to the outer door groove.

7. The refrigerator of claim 1, wherein:
the inner door protrusion includes an inner door groove recessed to prevent interference caused by a rotation of the outer door, in one side adjacent to the inner door shaft among both sides of the inner door protrusion in a direction that is perpendicular to an extension direction of the inner door shaft.

8. The refrigerator of claim 7, wherein:
the inner door groove extends from a front side of the inner door protrusion toward a rear side that is opposite to the front side.

9. The refrigerator of claim 7, wherein,
while the outer door is opened to a preset angle or more with respect to the inner door, a part of the outer door adjacent to the outer door upper shaft is accommodated in the inner door groove.

10. The refrigerator of claim 7, wherein:
a portion of the inner door groove overlaps a portion of the outer door groove.

11. The refrigerator of claim 1, wherein:
the inner door protrusion includes an inner door shaft hole to which the inner door shaft is coupled, and
the inner door shaft hole is formed in one side of the inner door protrusion, which is spaced from the outer door shaft.

12. The refrigerator of claim 1, further comprising:
a hinge bracket connecting the inner door shaft to the main body,
wherein the inner door protrusion is positioned between the hinge bracket and the outer door shaft in a direction that is parallel to a rotation axis of each of the inner door and the outer door.

13. The refrigerator of claim 1, further comprising:
a hinge bracket connecting the inner door shaft to the main body,
wherein, while the outer door is closed with respect to the inner door, a part of the hinge bracket is configured to be accommodated in the outer door groove.

14. The refrigerator of claim 1, wherein:
the outer door shaft is coupled to an inner wall of the outer door groove.

15. The refrigerator of claim 1, wherein:
the outer door shaft is supported by the inner door protrusion.
